(19) United States
(12) Patent Application Publication
(10) Pub. No.: US 2004/0049754 A1
(43) Pub. Date: Mar. 11, 2004

(54) Method and apparatus for filling and connecting filler material in a layout

(75) Inventors: Hongmei Liao, Littleton, MA (US); Spencer M. Gold, Pepperell, MA (US)

Correspondence Address: LAHIVE & COCKFIELD, LLP., 28 STATE STREET, BOSTON, MA, 02109, US

(73) Assignee: Sun Microsystems, Inc., Santa Clara, CA

(21) Appl. No.: 10/236,125

(22) Filed: Sep. 6, 2002

(51) Int. Cl. G06F 17/50

(52) U.S. Cl. 716/8

(57) ABSTRACT

A method and apparatus are provided for depositing a filler material in a physical layout for an integrated circuit. The filler material is deposited on a layer by layer basis in the physical layout so that a channel length of the filler material has an orientation that differs between immediately adjacent layers. In addition, the filler materials in each of the layers are grouped into a first group and a second group wherein the filler material associated with the first group is coupled to a first portion of a power grid in the integrated circuit and the filler material associated with the second group is coupled to a second portion of the power grid in the integrated circuit. The tiller materials associated with each group are interconnected using one or more vias so that the filler material is capable of expanding the power grid of the integrated circuit to assist in the distribution of power throughout the various layers of the integrated circuit.

### TECHNICAL FIELD OF THE INVENTION

The present invention generally relates to an integrated circuit, and more particularly, to the design and fabrication of an integrated circuit.

### BACKGROUND OF THE INVENTION

Filler material or filler metal, such as dummy metal, is often added to a layout for an integrated circuit to achieve a near uniform wafer surface topography or planarization, during fabrication of the integrated circuit. Achieving a selected degree of planarization of a wafer surface topography allows integrated circuits having multilevel interconnect systems to be fabricated with reliable electrical connections. The filler material is used to fill canyons, crevices and open spaces in the layout that occur between interconnections and various component features.

Moreover, the filler material is often added to the layout for an integrated circuit to meet a desired metal utilization density in the integrated circuit. Achieving the desired metal utilization density in the layout for the integrated circuit operates to prevent areas of the wafer from delaminating during a chemical mechanical polishing (CMP) operation. The CMP operation is often used during the fabrication of the wafer for selective material removal from the wafer surface. CMP is capable of achieving planarized wafer surface distances up to about several millimeters.

Unfortunately, despite the benefits that the addition of filler material to a layout achieve, the filler material is often left electrically floating, which allows the filler material to act like an antenna due to its capacitive affect and introduce noise into adjacent interconnections and component features. Alternatively, to mitigate the antenna effect of having a filler material electrically floating, the filler material is coupled to ground.

### SUMMARY OF THE INVENTION

The present invention addresses the above-described limitations associated with adding filler material to a layout for an integrated circuit. The present invention provides an approach for adding filler material to the layout of an integrated circuit that minimizes the coupling capacitance associated with the filler material to minimize the introduction of noise and to realize a reduction in the level of a voltage drop of a power bus associated with one or more components switching from a first state to a second state.

In one embodiment of the present invention, a method is practiced in an electronic device by providing a representation of a portion of an integrated circuit. The representation is partitioned into cells with each cell including a layout for at least one logical component and the layout having at least two layers. From each of the cells, locations are identified that are suitable for depositing with a filler material. The suitable locations in each of the cells are identified on a layer by layer basis.

Each of the suitable locations identified is filled with a filler material in a manner that controls an orientation of the filler material on a layer by layer basis. As such, the suitable locations in the first layer of a cell are filled with the filler material having a first orientation and the suitable locations in the second layer of the cell are filled with the filler material having a second orientation. As a result, a channel associated with a filler material in the first layer has a substantially perpendicular relationship with a channel associated with a filler material in the second layer.

The filler material is further identified as belonging to a first set or a second set in each of the cells. The filler material identified as belonging to the first set is coupled to a first portion of a power grid in the integrated circuit and the filler material associated with the second set is coupled to a second portion of the power grid in the integrated circuit. In addition, if filler material associated with the first set and if filler material associated with the second set are identified as not suitable for coupling to their respective portions of the power grid the identified filler material is removed from the layout to avoid having any electrically floating filler material.

A suitable location in a cell is filled with the filler material by inserting a representation of the filler material in the selected location and expanding the representation in a direction appropriate for the orientation of the selected layer until a dimensional constraint on the filler material or the location is encountered. If necessary additional representations of the filler material can be entered and expanded to substantially fill a selected location.

The above-described approach benefits an integrated circuit having an interconnect system with two or more levels of metal. As a result, an integrated circuit can achieve an improved power distribution scheme, which, in turn, results in a lower voltage drop in the power distribution network when the various components in the integrated circuit switch from a first state to a second state. Consequently, switching speed is improved in the integrated circuit while at the same time achieving a reduction in a noise level commonly associated with a voltage drop of the power distribution network caused by component switching.

In accordance with another aspect of the present invention, an apparatus for use in generating a layout for an integrated circuit having a plurality of layers is provided. The apparatus includes a display device for viewing by a user, an input device for use by the user and a layout facility for filling one or more portions of the layout with a dummy metal on a layer by layer basis. The layout facility fills the one or more portions of the layout with the dummy metal in a manner that results in the dummy metal in each of the plurality of layers having a layout orientation that differs from an immediately adjacent layer. In addition, the layout facility for each layer in the layout alternatively couples a first portion of the dummy metal to a first portion of a power grid and couples a second portion of the dummy metal to a second portion of the power grid. The first portion of the power grid is associated with a first power source supplying a positive voltage (VDD) and the second portion of the power grid is associated with a second power source supplying ground (VSS). The layout facility orients the dummy metal between adjacent layers in a manner that results in the formation of a cross-stitch pattern between the dummy metals placed in adjacent layers. The cross-stitch pattern of the dummy metal in adjacent layers results in a dummy metal orientation that differs by about 90° between immediately adjacent layers.

The above-described approach benefits an integrated circuit that uses two or more metal layers. Because the dummy metal is oriented in a manner to form a cross-stitch pattern between immediately adjacent layers, coupling capacitance between the dummy metal and an adjacent signal channel is minimized. Consequently, the reduction in coupling capacitance between the dummy metal and the adjacent signal channels results in a reduction in the amount of noise mutually coupled between the dummy metal and the signal connection.

In yet another aspect of the present invention, a method is practiced in an electronic device by providing a representation of an integrated circuit that includes cells. Each cell has at least two layers and includes at least a single logical component. The electronic device fills one or more open areas in each of the cells with a conductive material and groups the conductive material in each of the cells into a first group and a second group. The conductive material associated with the first group is coupled to a first node in the representation having a first voltage potential and the conductive material in the second group is coupled to a second node in the representation having a second voltage potential. The method further provides the identification of keep out areas in each of the cells wherein the keep out areas designate open areas in each of the cells that should not be filled with the conductive material. In each of the identified keep out areas, the conductive material is prevented from being filled in those locations. The conductive material is filled on a layer by layer basis in a manner that results in the conductive material having a first orientation in a first layer and the conductive material having a second orientation in a second layer. The first orientation of the conductive material in the first layer is substantially perpendicular to the second orientation of the conductive material in the second layer.

The above-described approach benefits a microprocessor architecture that uses a multi-layer interconnect layout. By adding a conductive material in one or more suitable locations in the layout, a desired metal utilization density is achieved, which, in turn, facilitates the achievement of a global planerization (i.e. over wafer surface distances greater than 10 microns) of both dielectric and metal layers, while improving power distribution in the integrated circuit. As a consequence, wafer fabrication process margins are improved which results in an improved wafer yield and an improved reliability factor for the integrated circuit due to the improvement in power distribution in the integrated circuit.

In still another aspect of the present invention, a device readable medium holding device executable instructions for an electronic device is provided. The device readable medium allows the electronic device to modify a representation of at least a portion of an integrated circuit by identifying locations in the representation suitable for depositing with a filler material. The suitable locations are identified on a layer by layer basis from the representation. The identified suitable locations are filled with a filler material in a manner that controls an orientation of the filler material in each layer of the representation. As a result, the orientation of the filler material in a first layer is substantially perpendicular to the orientation of the filler material in a second layer of the representation of the integrated circuit. The device readable medium further allows the electronic device to identify the filler material in each of the layers as belonging to a first set or a second set. The identified filler material in the first set is then coupled to a first portion of a power grid in the integrated circuit and the filler material in the second set is coupled to a second portion of the power grid in the integrated circuit.

### BRIEF DESCRIPTION OF THE DRAWINGS

An illustrative embodiment of the present invention will be described below relative to the following drawings.

FIG. 1 illustrates an exemplary cell from a layout of an integrated circuit having a filler material in a first layer oriented in a first direction and a filler material in a second layer oriented in a second direction in accordance with an illustrative embodiment of the present invention.

FIG. 2 illustrates an exemplary cell from a layout of an integrated circuit having a layer filled with a filler material in accordance with an illustrative embodiment of the present invention.

FIG. 3 is a flow diagram that illustrates steps taken to practice an illustrative embodiment of the present invention.

FIG. 4 is an illustrative flow diagram that illustrates steps taken to fill a portion of a layout for an integrated circuit with a filler material in accordance with an illustrative embodiment of the present invention

FIG. 5 is a continuation of the flow diagram illustrated in FIG. 4.

FIG. 6 depicts an apparatus suitable for practicing an illustrative embodiment of the present invention.

### DETAILED DESCRIPTION

The illustrative embodiment of the present invention provides an apparatus and method for use in achieving a substantially planarized wafer surface topography for an integrated circuit by filling suitable open spaces with a filler material. In the illustrative embodiment, the layout is filled with the filler material on a layer by layer basis in a manner that results in the filler material in each layer of an integrated circuit having an orientation that differs from an immediately adjacent layer. The filler material in each of the layers of the integrated circuit is further coupled in an alternating manner to a first and second portion of the power grid of the integrated circuit. Vias are also used to interconnect the filler material between layers of the integrated circuit. In this manner, the filler material in each layer associated with a first portion of the power grid is interconnected between layers and the filler material associated with the second portion of the power grid is interconnected between layers.

In the illustrative embodiment, the method and apparatus are attractive for use in designing a physical layout for an integrated circuit. The method and apparatus allows an integrated circuit, such as a microprocessor or an application specific integrated circuit (ASIC) to improve power distribution throughout the integrated circuit while reducing an amount of noise associated with the capacitive effects of filler material in the integrated circuit. The illustrative embodiment of the present invention allows for filler material to be placed in a pattern that reduces capacitive coupling of noise between the filler material and adjacent signal paths, including signal paths in layers immediately above and below the filler material, while achieving a metal density suitable to support CMP of the wafer.

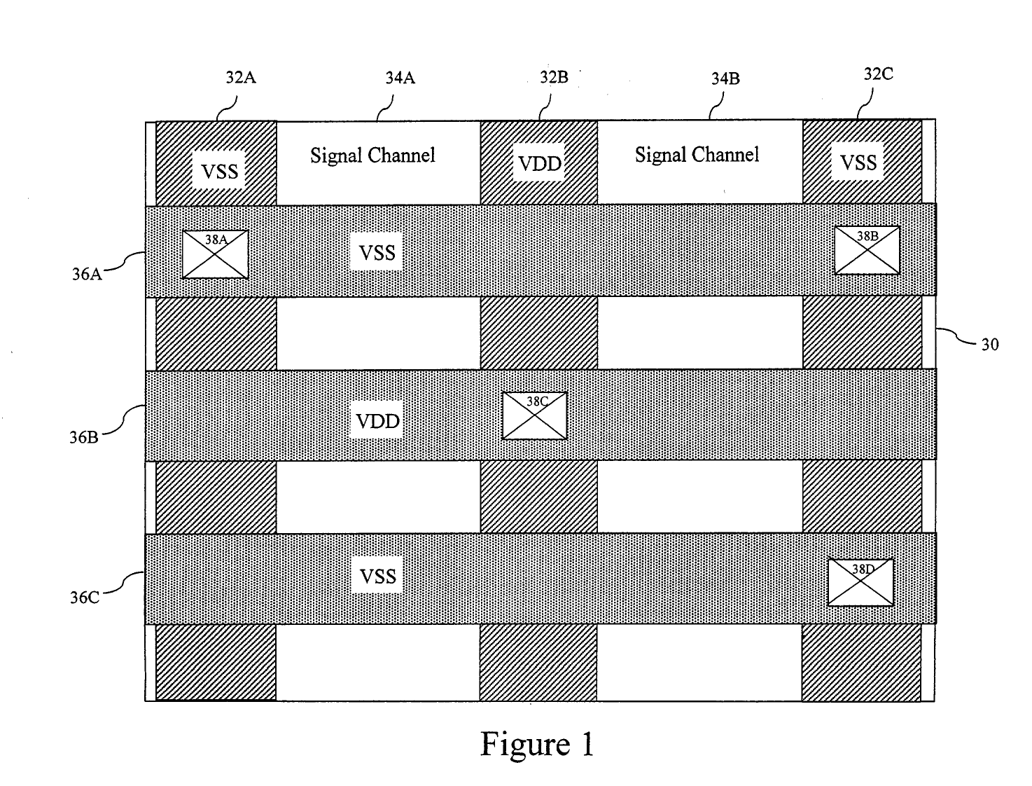

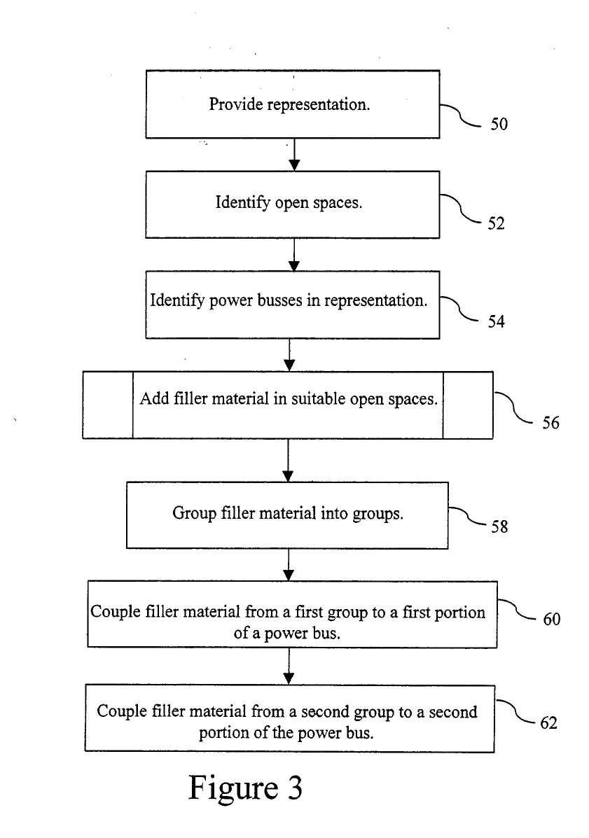

FIG. 1 illustrates an exemplary cell 30 from a representation of an integrated circuit. Those skilled in the art will recognize that a cell is a logical construct containing a collection of electrical representations that represent interconnections and electrical components, such as transistors, contacts and logic gates. The exemplary cell 30 has at least two layers and includes a number of suitable open spaces in a first layer filled with a filler material 32A, 32B and 32C and a number of suitable open spaces in a second layer filled with a filler material 36A, 36B and 36C. The filler material 32A, 32B and 32C and the filler material 36A, 36B and 36C are deposited or filled in the exemplary cell 30 in accordance with an illustrative embodiment of the present invention. The filling or depositing of the filler material 32A-32C, and 36A-36C are discussed below in more detail with reference to FIGS. 3, 4, and 5.

The first layer of the exemplary cell 30 includes a first signal channel 34A and a second signal channel 34B that propagate one or more signals between one or more nodes or components in the integrated circuit. The filler material in the first layer is filled in a manner that orients a channel length of each of the filler materials in a like direction. For example, the filler material 32A, 32B and 32C in the first layer each have their respective channels oriented in a like manner and the filler material 36A, 36B and 36C in the second layer each have their respective channels oriented in a like manner. As the exemplary cell 30 illustrates, the orientation of the filler material 32A, 32B and 32C in the first layer with reference to the orientation of the filler material 36A, 36B and 36C in the second layer are out of phase by about ninety degrees to form a cross-stitch pattern.

The filler material in each layer of the exemplary cell 30 fills a number of suitable locations. For example, the filler material 32A fills an area located between the signal channel 34A and a first outer most boundary in the first layer of the exemplary cell 30. The filler material 32B fills an area between the signal channel 34A and the signal channel 34B in the first layer of the exemplary cell 30. Similarly, the filler material 32C fills an area between the signal channel 34B and another outer boundary in the first layer of the exemplary cell 30.

In like fashion, the filler materials 36A through 36C in the second layer of the exemplary cell 30 fill areas between an outer boundary of the exemplary cell 30, and one or more signal channels (not shown), or areas between one or more component features (not shown) in the second layer of the exemplary cell 30. Those skilled in the art will appreciate that the second layer of the exemplary cell 30 is illustrated without signal channels, or functional blocks that represent components or features of components to better illustrate the relationship of the filler material between immediately adjacent layers. The lack of functional blocks or signal channels in the second layer of the exemplary cell 30 is not meant to limit the illustrative embodiment, but rather facilitate explanation. The filler materials 32A through 32C and the filler materials 36A through 36C have a rectangular shape or channel which illustrates how the filler material in immediately adjacent layers are substantially oriented in a substantially perpendicular fashion.

The filler materials 32A through 32C and the filler materials 36A through 36C illustrated in the exemplary cell 30 are coupled in an alternating manner to a first portion of a power grid or to a second portion of the power grid for the integrated circuit. For example, filler materials 32A and 32C are coupled to VSS and filler material 32B is coupled to VDD. In similar fashion in the second layer, filler materials 36A and 36C are coupled to VSS and filler material 36B is coupled to VDD.

To interconnect the filler materials between layers, vias are used to interconnect the filler materials assigned to like portions of the power grid. The exemplary cell 30 includes a first via 38A that couples the filler material 36A and the filler material 32A to VSS. The filler material 36A is coupled to the filler material 36C and VSS through via 38B. In like fashion, the filler material 36B is coupled to the filler material 32B and VDD with via 38C. Similarly, the filler material 36C is coupled to the filler material 32C and to VSS by via 38D. In this manner, the filler materials associated with the various layers in the exemplary cell 30 can be interconnected from a top layer to a bottom layer and to their respective portion of the power grid to which each filler material is assigned. Consequently, the interconnecting of the filler material assigned to a like portion of a power grid in an integrated circuit facilitates power distribution throughout the integrated circuit. As a result of the improved power distribution in the integrated circuit, interconnections in the integrated circuit between the power grid and a component can be shortened, which, in turn, reduces a voltage drop associated with the length of the interconnection between the power grid and a component. Moreover, the reduction in length of the interconnection between the power grid and the component also realizes a reduction in the amount of inductance and capacitance associated with the interconnection, which, allows the integrated circuit to realize a lower noise voltage component that typically rides on the power grid as a result of fluctuating current values caused by the components of the integrated circuit switching from a first state to a second state.

The filler material 32A through 32C and the filler material 36A through 36C is often referred to in the art as filler metal or dummy metal. The filler material 32A through 32C and the filler material 36A through 36C are deposited adjacent to signal interconnections and adjacent to functional blocks, such as a feature of a discrete component. The filler material in the exemplary cell 30 is deposited or filled in the suitable open spaces on a layer by layer basis. The details of depositing or filling the filler material as illustrated in FIG. 1 are discussed in more detail below with reference to FIGS. 3, 4 and 5.

The filler material illustrated in the exemplary cell 30 is deposited or filled in a manner that controls the filler materials layer density on a per layer basis and in a manner that controls a number of dimensional aspects of the filler material. Dimensional aspects of the filler material that are controlled include a minimum surface area of the filler material, a thickness dimension of the filler material, a line or channel width dimension of the filler material, and a line or channel length dimension of the filler material. An additional dimensional aspect that is controlled is a minimum open space or keep out area between a deposited filler material and a signal channel or component feature. The various dimensional requirements for the filler material are listed below in Table I. Those skilled in the art will recognize that the dimensional values and limits listed in Table I are merely illustrative and that other dimensional values and limits are suitable for use in practicing the illustrative embodiment of the present invention. For example, those skilled in the art will recognize that minimum line lengths, spacing requirements and filler densities of the filler material can vary depending on the number of metal layers or the fabrication techniques used to fabricate the integrated circuit.

TABLE 1

| | Minimum | | Filler | Minimum |
|---|---|---|---|---|
| | Spacing Between | | Material | Length of |
| | Filler Material | | Line | Filler |
| | and Activity | Filler | Width (LW) | Material |
| | Metal (microns) | Density | (microns) | (microns) |
| METAL | | | | |
| LAYER | | | | |
| 1 | 1.0 | 20%-80% | 0.8 ≦ LW ≦ 4.0 | 2.5 |
| 2 | 1.0 | 20%-80% | 0.8 ≦ LW ≦ 4.0 | 2.5 |
| 3 | 1.0 | 20%-80% | 0.8 ≦ LW ≦ 4.0 | 2.5 |
| 4 | 1.0 | 20%-80% | 0.8 ≦ LW ≦ 4.0 | 2.5 |
| 5 | 1.14 | 20%-80% | 1.5 ≦ LW ≦ 6.0 | 4.0 |
| 6 | 1.14 | 20%-80% | 1.5 ≦ LW ≦ 6.0 | 4.0 |
| 7 | 2.34 | 20%-80% | 3.0 ≦ LW ≦ 8.0 | 6.0 |
| 8 | 2.34 | 20%-90% | 3.0 ≦ LW ≦ 8.0 | 6.0 |

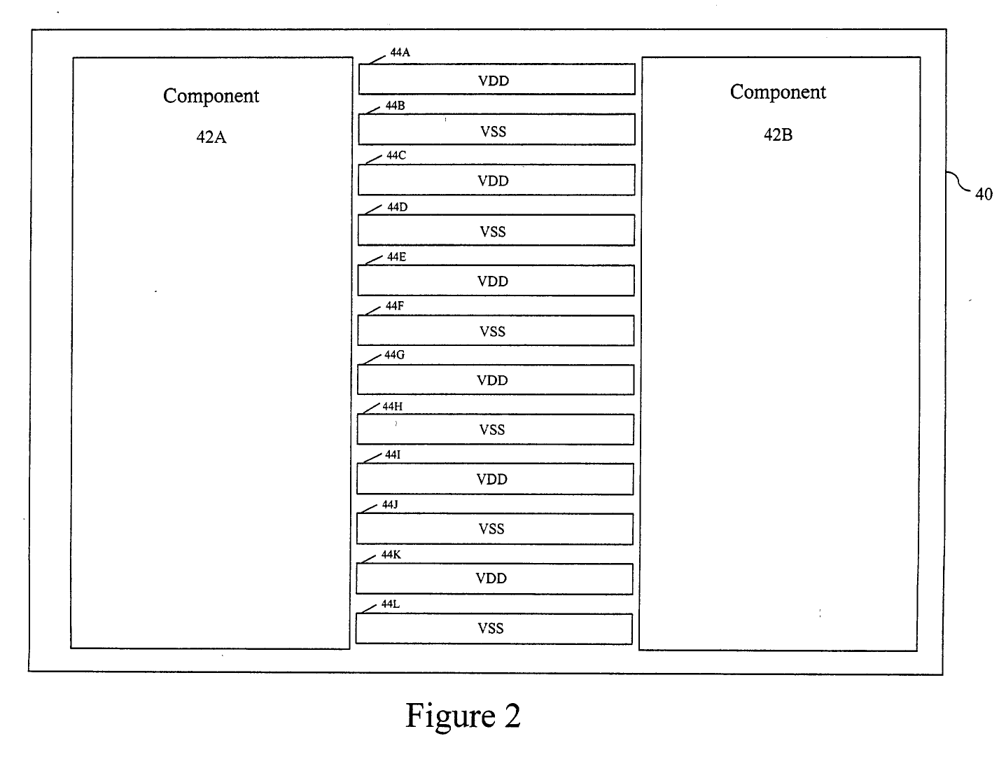

FIG. 2 illustrates an exemplary cell 40 in a representation of an integrated circuit containing cells. The exemplary cell 40 includes a first component feature 42A and a second component feature 42B. Deposited between the first component feature 42A and the second component feature 42B are filler materials 44A through 44L. The filler materials 44A through 44L are deposited with a common orientation as illustration in FIG. 2. That is, a channel length of the filler materials 44A through 44L is oriented in a horizontal direction. Nevertheless, the channel length of the filler materials 44A through 44L can be oriented in a vertical direction if the orientation of the filler material in an immediately adjacent layer is oriented in a horizontal manner. The common orientation of the filler materials 44A through 44L indicates a common layer in which the filler materials are filled or deposited. The filler materials 44A through 44L are alternately coupled to either VDD or VSS in similar fashion to the filler material 32A through 32C and 36A through 36C.

FIG. 3 is a flow diagram that illustrates the steps taken to fill one or more cells in a representation of an integrated circuit with a filler material in accordance with an illustrative embodiment of the present invention. To begin filling a layout for an integrated circuit with filler material in accordance with an illustrative embodiment of the present invention, a representation of the integrated circuit is first provided (step 50 in FIG. 3). The representation provides a physical layout for the integrated circuit and contains one or more cells with each cell having at least one logical component and at least two layers. For each cell in the representation open spaces between interconnections and features of the logical component are identified as locations for filling or depositing with a filler material to achieve a suitable wafer surface topography and to achieve a desired metal density in the integrated circuit (step 52 in FIG. 3). From the provided representation, a power grid or a portion of the power grid is identified in each of the cells for the integrated circuit (step 54 in FIG. 3).

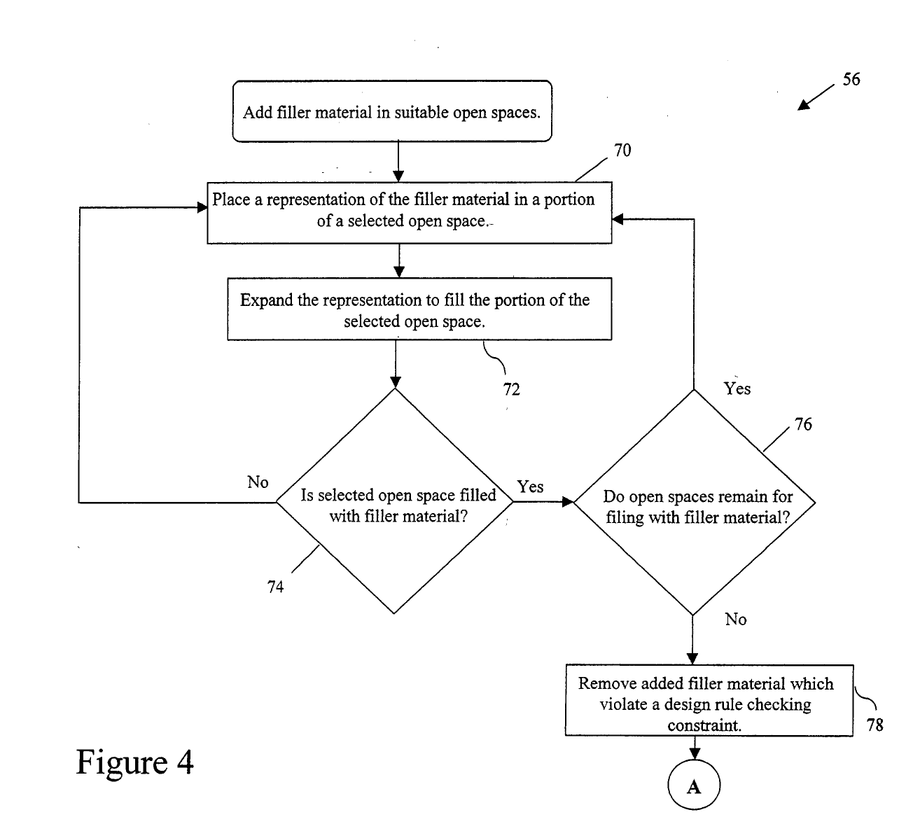

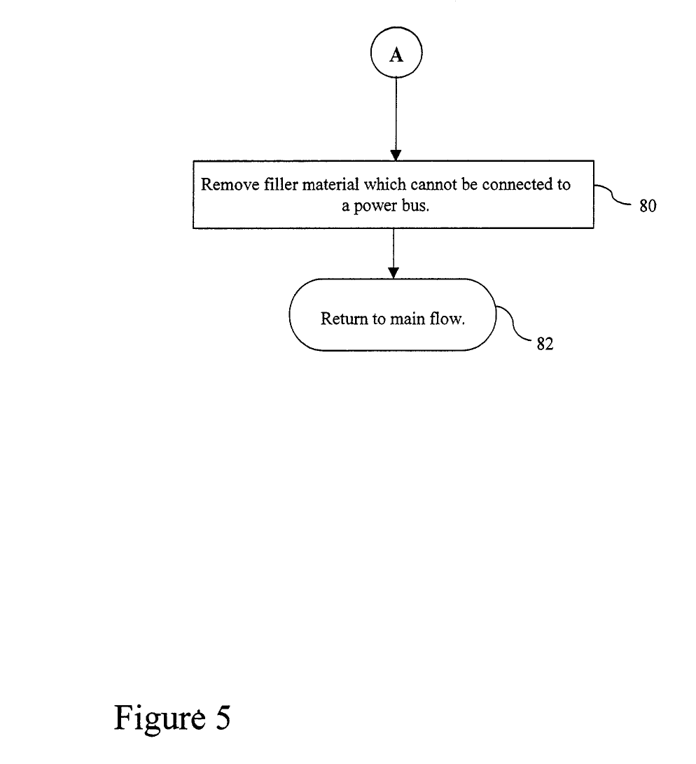

Having identified the open spaces and the power grid in each of the cells in the provided representation, the filler material is added to suitable open spaces (step 56 in FIG. 3). Suitable open spaces are spaces having a minimum size for accepting the filler material. Suitable spaces do not include spaces that are designated as a keep out area. The filler material is added in a layer by layer basis in each of the cells. As the filler material is added to the suitable open spaces in each of the cells, the filler material is oriented in first direction in a first layer and oriented in a second direction in an immediately adjacent layer. In this manner a channel length of each of the filler materials in the first layer are oriented in a perpendicular fashion relative to a channel length of each of the filler materials in an immediately adjacent layer. The adding of the filler material to the suitable open spaces is discussed in more detail below with reference to FIGS. 4 and 5.

Once the suitable open spaces in each layer of each of the cells in the representation of the integrated circuit are filled with the filler material, the filler material is divided into a first group and a second group on a layer by layer basis (step 58 in FIG. 3). This division seeks to attain an even distribution of filler material between each of the groups and as such alternately assigns the filler material in each of the layers to each of the groups.

The filler material associated with the first group is coupled to a first portion of the power grid using one or more vias (step 60 in FIG. 3). The vias interconnect the filler material in a hierarchical manner. In this manner, a channel of the filler material associated with the first group in an upper layer of the cell is interconnected to a channel of a filler material associated with the same group in a lower layer of the cell. The vias are placed in a manner that couple the channels of the filler material between layers of each of the cells to facilitate power distribution through out the integrated circuit. The vias that interconnect the one or more channels of the one or more filler materials in one or more layers of a cell are placed in a manner that avoids interfering with a signal, control or power interconnection or with a feature of a logical component, or with a designated keep out area. The filler material associated with the second group is coupled to a second portion of the power grid in a fashion similar to the filler material associated with the first group (step 62 in FIG. 3).

The approach described above for depositing a filler material and connecting the filler material in the various layers with one or more vias to one or more portions of the power grid in each cell of an integrated circuit is suitable for use with one or more representations of an original cell. In this manner an instance of the original cell can be created to hold the filler material while leaving the original cell free of the filler material. In this manner, the instance provides a vehicle to modify the filler material placed in the cell prior to finalizing the physical layout for the integrated circuit without disrupting the layout in the original cell until the design reaches a desired level of maturity. Moreover, the filler material placed in each of the suitable open spaces in each of the cells complies with design rule checking (DRC) requirements, for example, compliance with a requirement for redundant vias, compliance with a requirement for minimum area sizes for filling with the filler material and other suitable DRC rules applicable to the technology type being fabricated.

FIG. 4 illustrates in more detail the steps taken to fill a selected area with a filler material in accordance with an illustrative embodiment of the present invention (see step 56 in FIG. 3). Having identified a suitable open space in a layer of a cell from a representation of an integrated circuit, a representation of the filler material is placed in a portion of the selected open space (step 70 in FIG. 4). The selected open space is based on a number of dimensional criteria, which are exemplary identified above in Table I. Those skilled in the art will appreciate that the dimensional criteria is dependent on factors such as the layer selected in the current cell, fabrication techniques to be used and technology type being fabricated. For example, a suitable open space in a metal one layer should have enough area to place a representation of the filler material having a minimum length of about 2.5 microns and minimum width of about 0.8 microns. In addition, the suitable space must provide at least about 1.0 microns spacing between the filler material and an interconnection or a feature of a component associated with the selected layer in the selected cell.

Having placed the representation of the filler material in a portion of the selected open space, the representation is expanded to fill the portion of the selected open space in keeping with the dimensional constraints of the filler material in the selected layer of the cell (step 72 in FIG. 4). The representation is capable of being expanded in both a length dimension and a width dimension. If after expanding the representation to its maximum dimensions in accordance with the predefined filler material constraints for that layer, it is determined whether the selected open space contains enough open space to place an additional representation of the filler material (step 74 in FIG. 4). If suitable space is available in the selected open space, an additional representation of the filler material is placed in the open space (step 70 in Figure) and is expanded to fill an additional portion of the selected open space within the predefined filler dimensional constraints for the selected layer (step 72 in FIG. 4). If the selected space has been filled with the maximum amount of filler,material based on the predefined dimensional constraints for the filler material in the selected layer (step 74 in FIG. 4) the next suitable open space is selected (step 76 in FIG. 4) and the process begins again of placing a representation of the filler material in a portion of the selected open space and expanding the representation. The suitable open spaces are selected and filled on a layer by layer basis. The process is complete after each open space in each layer of the cell has been identified and a suitable number of spaces determined to be suitable for filling with the filler material are filled with the filler material so that the selected layer has achieved a desired filler material density. Those skilled in the art will recognize that an open space in each of the layers can be determined to be unsuitable if the amount of the filler material in a selected layer has reached a level to satisfy a metal density requirement for the selected layer.

If there remains no suitable open spaces in any of these cells in the representation of the integrated circuit (step 76 in FIG. 4) the placed filler material is reviewed for DRC violations. Any of the added filler material identified as violating a DRC constraint is removed from the representation of the integrated circuit (step 78 in FIG. 4). Each of the cells in the representation is further reviewed to identify and remove filler material that cannot be connected to a power bus or power grid in the integrated circuit (step 80 in FIG. 5). Once the filler material has been removed that cannot be connected to a power bus or that violates a DRC constraint, the process returns to the main flow depicted in FIG. 3.

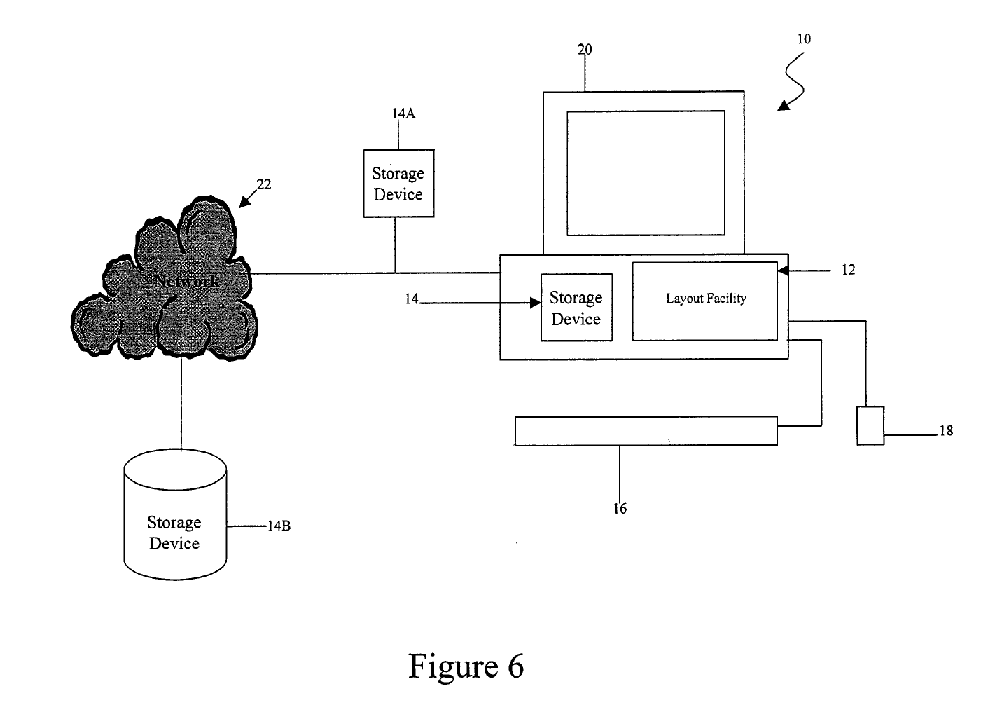

FIG. 6 illustrates an apparatus 10 suitable for filling a layout for an integrated circuit with filler material in accordance with an illustrative embodiment of the present invention. The apparatus 10 includes a keyboard 16, a pointing device 18, such as a mouse, light pen or other like pointing devices and a display 20 to display a representation of an integrated circuit. The apparatus 10 also includes a storage device 14, such as hard drive or an optical drive that can read or write an optical disk, and a layout facility 12. The layout facility 12 is capable of filling a layout of an integrated circuit with a filler material in a manner that orients the filler material in a first direction in a first layer of the layout and orients the filler material in a second direction in an immediately adjacent layer. The layout facility 12 is also capable of grouping the filler material in each of the layers into a first group and a second group and coupling the filler material associated with the first group to a first portion of a power grid and coupling the filler material associated with the second group to a second portion of the power grid.

The apparatus 10 is adaptable to communicate with a network 22, which can be a LAN, a WAN, a long haul network, the Internet, an intranet or other like network, that is considered wired, wireless, or a hybrid of wired and wireless. Communication between the apparatus 10 and the network 22 can be through one or more wire or cable mediums or with a wireless medium using terrestrial or satellite communications or a combination of mediums. The apparatus 10 is able to utilize the network 22 to communicate with a remote storage device 14B to store or retrieve a representation of an integrated circuit or to store or retrieve an instance of cell filled with the filler material. The use of the remote storage device 14B allows for multiple users associated with network 22 to use the representation of the integrated circuit. Alternately, the storage device 14B operates as a data center for archiving purposes or for other like purposes.

The apparatus 10 is capable of communicating with a local storage device 14A located externally to the apparatus 10, but in relatively close proximity thereto. The local storage device 14A can be a server or optical jukebox located in close proximity to the apparatus 10, for example, in the same laboratory or same floor, or same building and not associated with the network 22 for security reasons. In this manner, the apparatus 10 can utilize the storage capability of the remote storage device 14A to store the results of placing filler material in a representation of an integrated circuit in a highly secure manner.

In operation, the layout facility 12 identifies open areas in each layer of a cell from a representation of an integrated circuit that are suitable for filling with a filler material, such as dummy metal. The layout facility 12 identifies suitable areas by examining dimensions of each identified open area and determines if the open area has dimensions suitable for filling with a filler material. Those skilled in the art will recognize that the dimensional requirements for a suitable open area are dependant in part on a number of factors including, but not limited to, the layer in which the open area is associated, the filler material density in the selected layer, DRC constraints, designated keep out areas, and other like factors. The layout facility 12 upon identifying a suitable open area in a layer fills the area with the filler material in a manner that orients a channel length of the filler material in a direction suitable for the selected area.

The layout facility 12 after filling suitable open areas in a cell on a layer by layer basis so that the orientation of a channel length of the filler material in a first layer is oriented in a first direction relative to a channel length of the filler material in an immediately adjacent layer, groups the filler material into a first group and a second group. The layout facility 12 operates to fill a number of suitable open areas in each layer as described above in relation to FIGS. 3, 4, and 5. The layout facility 12 couples the filler material associated with the first group to a first portion of a power grid, for example VDD. In like fashion, the layout facility 12 couples the filler material associated with the second group to a second portion of the power grid, for example VSS. The layout facility places one or more vias through the like grouped filler material to interconnect the like grouped filler material from an upper layer to a lower layer. In this manner, the layout facility 12 facilitates power distribution through out the integrated circuit by expanding the power grid of the integrated circuit to include the filler material deposited in the integrated circuit.

While the present invention has been described with reference to a preferred embodiment thereof, one skilled in the art will appreciate that various changes in form and detail may be made without departing from the intended scope of the present invention as defined in the pending claims. For example, layout facility can reside on a remote electronic device, such as a server so that a number of engineers can access the layout facility from a number of client devices.

What is claimed is:

1. In an electronic device, an automatic method, comprising the steps of:
providing a representation of at least a portion of an integrated circuit, said portion including at least one cell wherein the cell includes a layout for at least one logical component, the layout having at least two layers;
identifying locations in the cell suitable for depositing with a filler material, the locations in the cell are identified on a layer by layer basis; and
identifying how to fill each of the suitable locations with the filler material to control an orientation of the filler material in each of the at least two layers so that the orientation of the filler material in a first of the at least two layers is substantially perpendicular to the orientation of the filler material in a second of the at least two layers.

2. T he method of claim 1, further comprising the steps of:
identifying a plurality of the suitable locations in each of the layers as belonging to a first set or to a second set; and
coupling the suitable locations in the first set to a first portion of a power grid in said representation of the integrated circuit and coupling the suitable locations in the second set to a second portion of the power grid in said representation of the integrated circuit.

3. The method of claim 1, wherein the step of identifying how to fill each of the suitable locations with the filler material comprises the steps of,
inserting a representation of the filler material in a selected one of the suitable locations;
expanding the representation in a direction to substantially fill the selected location, the direction in which the representation is expanded is based in part on the layer in which the selected location is located.

4. The method of claim 1, further comprising the steps of:
identifying the suitable locations in the first set and the second set that are not suitable for coupling to their respective portions of the power grid; and
removing the suitable locations identified as not suitable for coupling to their respective portions of the power grid from each the first set and the second set.

5. The method of claim 1, wherein the filler material comprises a conductive material.

6. The method of claim 1, wherein the first portion of the power grid corresponds to that portion of the power grid supplying VDD, and the second portion of the power grid corresponds to that portion of the power grid supplying VSS.

7. An apparatus for use in generating a layout for an integrated circuit having a plurality of layers, said apparatus comprising,
a display device for viewing by a user;
an input device for use by the user; and
a layout facility for filing one or more portions of the layout on a layer by layer basis with a representation of a dummy metal in a manner that results in the representation of the dummy metal in each of the plurality of layers having a layout orientation that differs from an immediately adjacent layer and the layout facility for each layer in the layout couples in an alternating manner a first portion of the representation of the dummy metal to a first portion of a power grid and couples a second portion of the representation of the dummy metal to a second portion of the power grid.

8. The apparatus of claim 7, wherein the first portion of the power grid is associated with a first power source supplying VDD, and the second portion of the power grid is associated with a second power source supplying VSS.

9. The apparatus of claim 7, wherein the layout orientation of the representation of the dummy metal differs between adjacent layers by about 90° to form a cross-stitch pattern between the representation of the dummy metal associated with the adjacent layers.

10. In an electronic device, a method, comprising the steps of:
providing a representation of an integrated circuit, wherein the representation includes a cell and wherein the cell has at least two layers and includes at least a single logical component;
filling one or more open areas in the cell with a representation of a conductive material;
grouping the representations of the conductive material in the cell into at least a first group and a second group; and
coupling the representations of the conductive material in the first group to a first node in said representation having a first voltage potential, and coupling the representation of the conductive material in the second group to a second node in said representation having a second voltage potential.

11. The method of claim 10, wherein the method further comprises the steps of,
identifying one or more keep out areas in the cell, the keep out areas designating open areas that should not be filed with the representation of the conductive material; and
preventing the one or more keep out areas from being filed with the representation of the conductive material.

12. The method of claim 10, wherein the one or more open spaces are located between one or more channels capable of propagating a signal, and between one or more component features in the cell.

13. The method of claim 10, wherein the step of filling the one or more open areas comprises, filling the one or more open areas in a first layer of the cell with the representation of the conductive material having a first orientation, and filing the one or more open areas in a second layer of the cell with the representation of the conductive material having a second orientation.

14. The method of claim 13, wherein the first orientation of the representation of the conductive material in the first layer of the cell is substantially perpendicular to the second orientation of the representation of the conductive material in the second layer of the cell.

15. The method of claim 10, wherein the conductive material comprises copper.

16. The method of claim 13, wherein a first portion of the representation of the conductive material having the first orientation is grouped into the first group and a second portion of the representation of the conductive material having the first orientation is grouped into the second group.

17. The method of claim 10, wherein the single logical component comprises at least one Metal Oxide Semiconductor Field Effect Transistor (MOSFET).

18. The method of claim 10, wherein the first node is associated with VDD and the second node is associated with VSS.

19. The method of claim 10, wherein at least one via couples a portion of the representation of the conductive material in the first group in each of the at least two layers.

20. The method of claim 10, wherein at least one via couples a portion of the representation of the conductive material in the second group in each of the at least two layers.

21. A device readable medium holding device executable instructions for an electronic device, said device readable medium allowing the electronic device to modify a representation of at least a portion of an integrated circuit, said portion being partitioned into at least one cell wherein the cell includes a layout for at least one logical component, the layout having at least two layers by performing the steps of:
identifying locations in the cell suitable for depositing with a filler material, the locations in the cell are identified on a layer by layer basis; and
identifying how to fill each of the suitable locations with the filler material to control an orientation of the filler material in each of the at least two layers so that the orientation of the filler material in a first of the at least two layers is substantially perpendicular to the orientation of the filler material in a second of the at least two layers.

22. The device readable medium of claim 21, further comprising the steps of:
identifying a plurality of the suitable locations in each of the layers as belonging to a first set or to a second set; and
coupling the suitable locations in the first set to a first portion of a power grid in said representation of the integrated circuit and coupling the suitable locations in the second set to a second portion of the power grid in said representation of the integrated circuit.

23. The device readable medium of claim 21, wherein the step of identifying how to fill each of the suitable locations with the filler material comprises the steps of,
inserting a representation of the filler material in a selected one of the suitable locations;
expanding the representation in a direction to substantially fill the selected location, the direction in which the representation is expanded is based in part on the layer in which the selected location is located.

24. The device readable medium of claim 21, further comprising the steps of:
identifying the suitable locations in the first set and the second set that are not suitable for coupling to their respective portions of the power grid; and
removing the suitable locations identified in the first set and the second set as not suitable for coupling to their respective portions of the power grid from the first set and the second set
